(19) United States
(12) Patent Application Publication
(10) Pub. No.: US 2026/0340575 A1
(43) Pub. Date: Oct. 29, 2026

(54) COMPUTATION DEVICE, PLANNING ASSISTANCE METHOD, AND PROGRAM

(71) Applicant: Hitachi, Ltd., Tokyo (JP)

(72) Inventors: Issei SUEMITSU, Tokyo (JP); Robert ELLIS, Tokyo (JP); Yaemi TERAMOTO, Tokyo (JP)

(21) Appl. No.: 19/115,126

(22) PCT Filed: Oct. 19, 2023
(86) PCT No.: PCT/JP2023/037830

§ 371 Date: Mar. 25, 2025

(30) Foreign Application Priority Data
Nov. 16, 2022 (JP) 2022-183444

(51) Int. Cl. G06Q 10/087

(52) U.S. Cl. CPC G06Q 10/0872

(57) ABSTRACT

Provided is a computation device with which it is possible to shorten the time involved in creating an operation plan in which uncertainty is accounted for. A draft scenario generation unit 33 generates a plurality of draft scenarios based on a risk distribution 21 in which uncertainty is expressed by probability. A baseline draft plan generation unit 34 generates a baseline draft plan based on a draft plan definition region 22 that indicates the range of determinate parameter values. An approximation evaluation unit 35 acquires, using an approximation evaluator 27, an approximation evaluation result obtained by evaluating an operational draft plan that combines the draft scenarios and the baseline draft plan. A draft scenario aggregation unit 36 aggregates the draft scenarios into a plurality of scenario groups based on the approximation evaluation result. A representative scenario selection unit 37 selects, for each scenario group, one of the draft scenarios belonging to the scenario group as a representative scenario, based on the approximation evaluation result.

### TECHNICAL FIELD

The present disclosure relates to a computation device, a planning assistance method, and a program.

### BACKGROUND ART

Operation of a complex system regarding which securing a high level of reliability is required, such as supply chain management (supply chain management: SCM) or an electrical power system or the like, requires planning of an operation plan that takes into account future uncertainties as risks. Uncertainty can be represented using parameters expressing future behavior regarding probability values or probability distributions. However, there is a problem that planning of operation plans directly using parameters indicating such probabilistic behavior is extremely difficult, and the range of application is limited. Accordingly, a method for representing uncertainty, using sets of parameters indicating each of behaviors that could occur as variance patterns, is generally employed as a method for representing uncertainty. In this case, the variance patterns of the parameters are referred to as risk scenarios. Risk scenarios have determinate values, and accordingly can be applied to planning of operation plans. However, in order to accurately evaluate uncertainties, there is a need to create and evaluate a sufficiently great number of risk scenarios in accordance with uncertainties.

PTL 1 discloses technology in which optimization calculation is performed to select an optimal variance pattern for each of a plurality of types of single risk scenarios, corresponding to each of a plurality of types of uncertainties, a sub-scenario set is selected from all single risk scenarios based on the results of the optimization thereof, and this sub-scenario set is used to optimize the whole.

### CITATION LIST

### Patent Literature

### [PTL 1]

Japanese Translation of PCT Application No. 2018-519607

### SUMMARY OF INVENTION

### Technical Problem

However, the technology described in PTL 1 performs optimization calculation of each single risk scenario presuming that optimization calculation of single risk scenarios can be executed at sufficiently high speed. Accordingly, there is a problem in that the technology described in PTL 1 is not readily applicable to complex systems and so forth in which optimization calculation of single risk scenarios is time-consuming.

An object of the present disclosure is to provide a computation device, a planning assistance method, and a program, which are capable of shortening the time involved in creating an operation plan in which uncertainty is accounted for.

### Solution to Problem

A computation device according to an aspect of the present disclosure is a computation device for assisting in planning of an operation plan regarding a planning target, the computation device including a draft scenario generation unit configured to generate, based on uncertainty information in which values of an uncertainty parameter relating to uncertainty concerning the planning target are expressed as a probability, a plurality of draft scenarios indicating values that the uncertainty parameter can take, a baseline draft plan generation unit configured to generate, based on definition region information indicating a range of values of a determinate parameter excluding the uncertainty parameter relating to the planning target, a plurality of baseline draft plans indicating values that the determinate parameter can take, an approximation evaluation unit configured to acquire, by using an approximation evaluator that has learned strict evaluation results evaluated a plurality of an operational draft plans for training obtained by a strict evaluator that evaluates an operational draft plan, which is a combination of the draft scenarios and the baseline draft plans, approximation evaluation results in which a plurality of the operational draft plans for evaluation are evaluated; an aggregation unit configured to aggregate the draft scenarios into a plurality of groups, based on the approximation evaluation results, and a selection unit configured to select, for each of the groups, one of the draft scenarios belonging to that group as a representative scenario, based on the approximation evaluation results.

### Advantageous Effects of Invention

According to the present invention, time involved in creating an operation plan in which uncertainty is accounted for can be shortened.

### BRIEF DESCRIPTION OF DRAWINGS

FIG. 1 is a diagram for describing cases to which the present disclosure is applicable.

FIG. 2 is a configuration diagram illustrating a configuration of a computation device according to a first embodiment.

FIG. 3 is a diagram showing an example of risk distribution.

FIG. 4 is a diagram showing an example of a draft plan definition region.

FIG. 5 is a diagram showing an example of scenario generation conditions.

FIG. 6 is a diagram showing an example of KPI designation information.

FIG. 7 is a diagram showing an example of training data.

FIG. 8 is a diagram showing an example of approximation evaluator information.

FIG. 9 is a flowchart for describing overall processing according to the first embodiment.

FIG. 10 is a flowchart for describing an example of approximation evaluator generation processing.

FIG. 11 is a diagram showing an example of scenario generation results.

FIG. 12 is a diagram showing an example of scenario aggregation results.

FIG. 13 is a diagram showing an example of a scenario aggregation results display screen.

FIG. 14 is a diagram showing an example of a scenario distribution display screen.

FIG. 15 is a diagram showing an example of a scenario weighting configuration screen.

FIG. 16 is a configuration diagram illustrating a configuration of a computation device according to a second embodiment.

FIG. 17 is a diagram showing an example of user-designated scenario information.

FIG. 18 is a configuration diagram illustrating a configuration of a computation device according to a third embodiment.

FIG. 19 is a diagram showing an example of approximation error evaluation conditions.

FIG. 20 is a flowchart for describing overall processing according to the third embodiment.

### DESCRIPTION OF EMBODIMENTS

Embodiments of the present disclosure will be described below concerning the drawings.

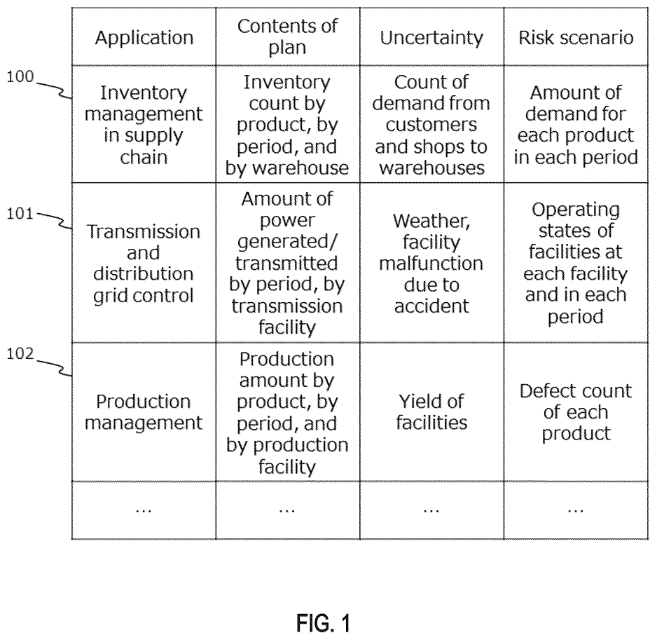

FIG. 1 is a diagram for describing applications, which are cases (planning targets) to which computation devices according to the embodiments of the present disclosure are applicable. In FIG. 1, plan contents that are contents of an operation plan to be planned, uncertainties to be taken into account when planning a plan, and risk scenarios corresponding to the uncertainties are shown for each application.

An application in record 100 in FIG. 1 is “inventory management in supply chain”. In this case, an inventory placement plan, which is a plan regarding count of inventory by product and by period in each warehouse in the supply chain, is planned so as to satisfy demands of customers or shops with minimal operating costs (monetary amount of inventory). At this time, the amount of demand that the warehouses are requested for by customers or shops is not uniquely determined at the time point of planning the inventory placement plan, and accordingly this is an uncertainty. In this case, patterns of amount of demand that could occur are risk scenarios.

An application in record 101 in FIG. 1 is “transmission and distribution grid control”. In this case, a transmission and distribution grid operation plan, relating to amount of electric power generated and amount of electric power transmitted in each period and at each facility, is planned such that power generation capabilities of various power plants, such as thermal power plants, nuclear power plants, wind energy plants, solar power stations, and so forth, are balanced concerning demand for electric power in each period and at each region. In this case, change in the amount of power generation due to weather, windspeed, and so forth, change in the amount of electric power that can be delivered, due to facility malfunctions under natural disasters, deterioration over time, and so forth, are uncertainties. In this case, changes in operating states of facilities at each facility and in each period due to uncertainties are risk patterns.

An application in record 102 in FIG. 1 is “production management”. In this case, a plan indicating how many of each product will be produced in which facility in each period concerning a target production count is planned. At this time, the amount of defects included in the products that are produced, i.e., yield, is an uncertainty. In this case, counts of defects are a risk scenario.

Note that the applications shown in FIG. 1 are only an example, and the computation device according to the present disclosure is applicable to other applications as well. Embodiments of the present disclosure will be described below by way of an example of the “inventory management in supply chain” shown in record 100 in FIG. 1.

### First Embodiment

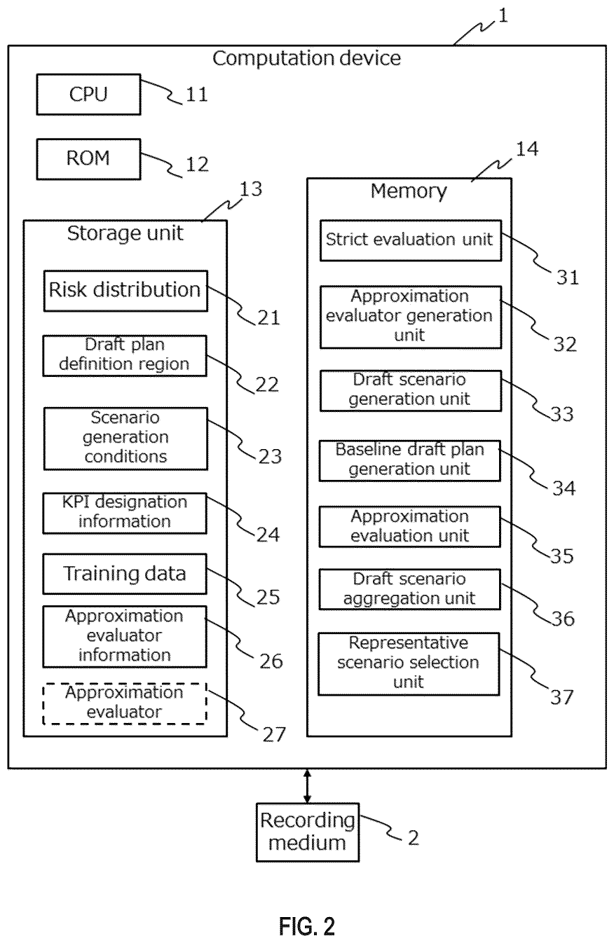

A first embodiment of the present disclosure will be described below concerning FIG. 2 to FIG. 15.

FIG. 2 is a configuration diagram illustrating a configuration of the computation device according to the present embodiment. The computation device 1 illustrated in FIG. 2 includes a CPU (Central Processing Unit) 11 that is a central processing unit, ROM (Read Only Memory) 12 that is a read-only storage device, a storage unit 13 that is a non-volatile storage device, and memory 14 that is a storage device capable of high-speed reading and writing. Later-described computation is performed by the CPU 11 loading programs (computer programs) stored in the ROM 12 to the memory 14 and executing the programs.

The computation device 1 may realize later-described functions by an FPGA (Field Programmable Gate Array) that is a rewritable logic circuit or an ASIC (Application Specific Integrated Circuit) that is an integrated circuit for particular use, instead of the combination of the CPU 11, the ROM 12, and the memory 14. Also, the computation device 1 may be realized by a different combination of configurations, such as a combination of the CPU 11, the ROM 12, the storage unit 13, and an FPGA, for example, instead of the combination of the CPU 11, the ROM 12, and the memory 14.

The storage unit 13 stores a risk distribution 21, a draft plan definition region 22, scenario generation conditions 23, KPI (Key Performance Indicator) designation information 24, training data 25, approximation evaluator information 26, and an approximation evaluator 27.

The risk distribution 21 is uncertainty information in which a value of an uncertainty parameter, which is a parameter relating to uncertainty, is expressed as a probability. The draft plan definition region 22 is definition region information indicating a range of values of a determinate parameter that has a determinate value, and that is different from the uncertainty parameter. The scenario generation conditions 23 are generation conditions for generating a scenario (risk scenario), or the like, indicating an implementation (value that can be taken) of the uncertainty parameter. The KPI designation information 24 is index designation information designating an evaluation KPI, which is an evaluation index for evaluating an operational draft plan. The training data 25 is data for generating the approximation evaluator 27 that is an approximation evaluation model that approximatively evaluates the operational draft plan. The approximation evaluator information 26 is information defining the approximation evaluator 27. Note that while the approximation evaluator 27 is illustrated in FIG. 2 for the sake of convenience, the primary configuration thereof is the approximation evaluator information 26.

Also, the computation device 1 includes, as functional configurations, a strict evaluation unit 31, an approximation evaluator generation unit 32, a draft scenario generation unit 33, a baseline draft plan generation unit 34, an approximation evaluation unit 35, a draft scenario aggregation unit 36, and a representative scenario selection unit 37. These functional configurations are realized by, for example, the CPU 11 loading programs stored in the ROM 12 to the memory 14 and executing the programs, as described above, and accordingly are described in FIG. 2 as being inside the memory 14, for the sake of convenience.

The strict evaluation unit 31 is a strict evaluator that generates the training data 25 for generating the approximation evaluator 27 by evaluating operational draft plans for training based on the risk distribution 21 and the draft plan definition region 22. The approximation evaluator generation unit 32 generates the approximation evaluator 27 using the training data 25 generated by the strict evaluation unit 31. The draft scenario generation unit 33 generates draft scenarios indicating implementations (values that can be taken) of the uncertainty parameter, based on the risk distribution 21 and the scenario generation conditions 23. The baseline draft plan generation unit 34 generates a baseline draft plan indicating implementation of the determinate parameter, based on the draft plan definition region 22 and the scenario generation conditions 23. The operational draft plan is made up of a combination of the draft scenario and the baseline draft plan.

The approximation evaluation unit 35 approximatively evaluates the operational draft plan in which the draft scenario and the baseline draft plan are combined. The draft scenario aggregation unit 36 aggregates the draft scenarios into a plurality of scenario groups based on approximation evaluation results that are the results of evaluation by the approximation evaluation unit 35. The representative scenario selection unit 37 selects one draft scenario included in the scenario groups as a representative scenario, to be a representative of these draft scenarios, based on approximation evaluation results that are results of evaluation by the approximation evaluation unit 35.

Note that a recording medium 2 that stores computer programs or data in a non-transitory manner may be communicably connected to the computation device 1. The recording medium 2 can be made to store at least part of the computer programs and data stored in the storage unit 13 and the memory 14.

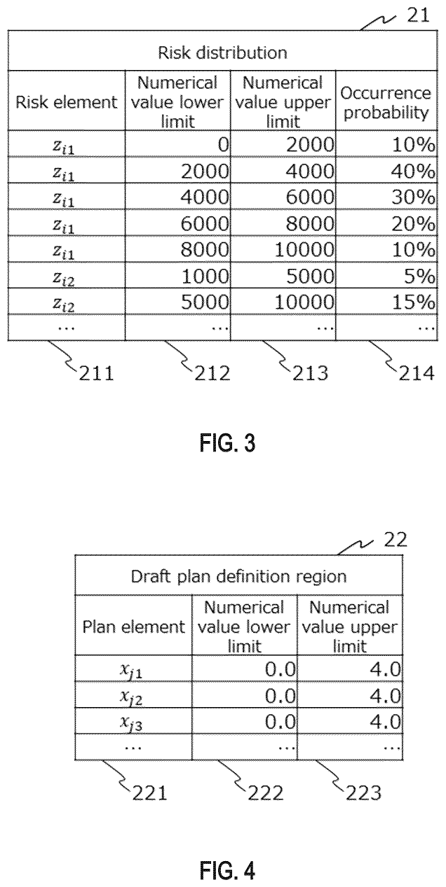

FIG. 3 is a diagram showing an example of the risk distribution 21. The risk distribution 21 shown in FIG. 3 includes fields 211 through 214. The field 211 stores risk elements that are uncertainty parameters. Risk elements are, for example, prediction of demand for each product during each period. The fields 212 and 213 store occurrence ranges, which are ranges of values that the risk elements can take. Specifically, the field 212 stores numerical value lower limits that are lower limit values of the occurrence ranges, and the field 213 stores numerical value upper limits that are upper limit values of the occurrence ranges. The field 214 stores occurrence probabilities that are probabilities of demand of the occurrence ranges occurring.

Note that the risk distribution 21 shown in FIG. 3 is only an example, and may be described in another format. For example, the risk distribution 21 may show, for each risk element, the type of probability distribution that the values of the risk elements follow, and defined values defining the probability distribution. For example, in a case in which the probability distribution of the risk elements can be expressed as a normal distribution, the type of probability distribution is “normal distribution”, and the defined values of the probability distribution are “average value” and “standard deviation”. Note that the values of the risk distribution 21 may be configured based on statistical information from the past or may be configured by a user of the computation device 1.

FIG. 4 is a diagram showing an example of the draft plan definition region 22. The draft plan definition region 22 shown in FIG. 4 includes fields 221 through 223. The field 221 stores plan elements that are determinate parameters. Plan elements are, for example, prediction of inventory volume of each product in each warehouse during each period. The fields 222 and 223 store definition regions, which are ranges of values that the plan elements can take. Specifically, the field 222 stores numerical value lower limits that are lower limit values of the definition regions, and the field 223 stores numerical value upper limits that are upper limit values of the definition regions. The definition regions may be configured based on statistical information of values from the past or may be configured by the user.

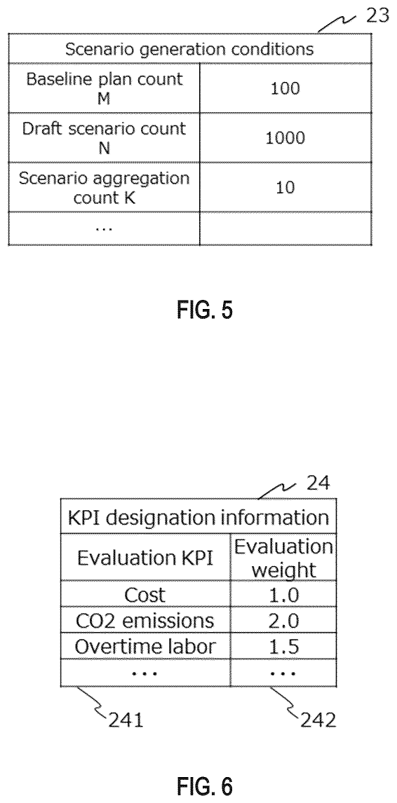

FIG. 5 is a diagram showing an example of the scenario generation conditions 23. The scenario generation conditions 23 shown in FIG. 5 show a draft scenario count N that is a count of draft scenarios for evaluation that are generated by the draft scenario generation unit 33, a baseline plan count M that is a count of baseline draft plans for evaluation that are generated by the baseline draft plan generation unit 34, and a scenario aggregation count K that is a count of scenario groups generated by the draft scenario aggregation unit 36, and so forth.

FIG. 6 is a diagram showing an example of the KPI designation information 24. The KPI designation information 24 shown in FIG. 6 includes fields 241 and 242. The field 241 stores types of evaluation KPIs. In the example in FIG. 6, cost, CO₂ emissions, and overtime labor are shown as evaluation KPIs, but the evaluation KPIs are not limited to these. The field 242 stores evaluation weights that are weighting values indicating the importance of the evaluation KPIs. For example, in a case of configuring the evaluation weight for CO₂ emissions to be twice as great as that for costs, one unit of variance of CO₂ emissions will be handled as being equivalent to two units of variance of costs in the scenario generation, and thus scenario generation with emphasis on change in CO₂ emissions can be performed.

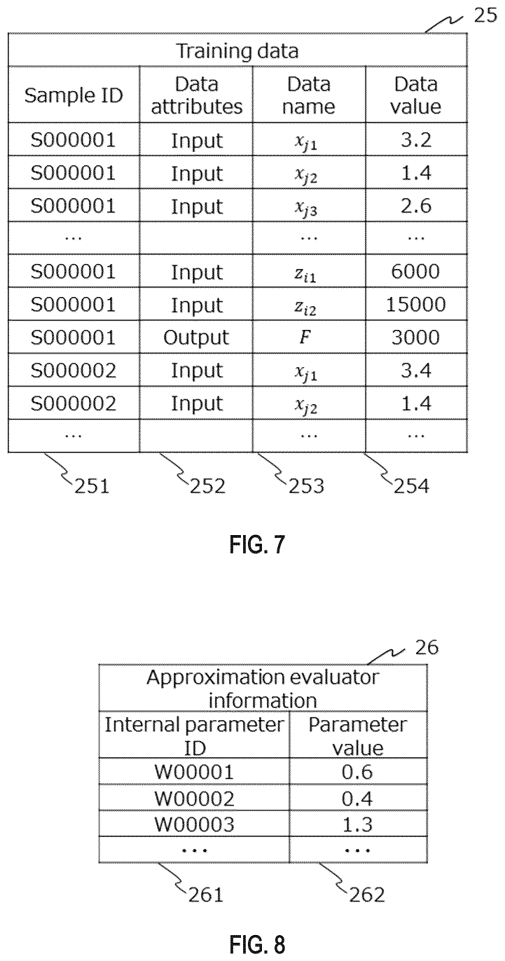

FIG. 7 is a diagram showing an example of the training data 25. Data may be stored in the training data 25 in advance or may be blank at the time point of starting approximation evaluator generating processing for generating the approximation evaluator 27. Also, the training data 25 includes a plurality of pieces of sample data (hereinafter may be referred to simply as samples), which are implementations of operation plans. Each sample includes a plurality of pieces of data, including input data that is input to the strict evaluation unit 31 and output data that is output from the strict evaluation unit 31. The input data is operational draft plans for training, and the output data is evaluation KPIs of having evaluated the operational draft plans.

Specifically, the training data includes fields 251 through 254. The field 251 stores sample IDs that are identification information for identifying samples. The field 252 stores data attributes that are attributes of data included in the samples. The data attributes are one of “input” that is input data input to the strict evaluation unit 31, and “output” that is output data output from the strict evaluation unit 31. The field 253 stores data names that are identification information for identifying the data included in the samples. The field 254 stores data values that are values of the data included in the samples. Note that regarding samples having the same sample ID, data of which the data attribute is “input” is input to the strict evaluation unit 31 at the same timing.

FIG. 8 is a diagram showing an example of the approximation evaluator information 26. The approximation evaluator information 26 shown in FIG. 8 includes fields 261 and 262. The field 261 stores internal parameter IDs that are identification information for identifying internal parameters making up the approximation evaluator information 26. The field 262 stores values of the internal parameters.

The approximation evaluator 27 is made up of a combination of the approximation evaluator information 26 and of unshown information: structure of the approximation evaluator 27. For example, the approximation evaluator 27 is a neural network, and is made up of a combination of information relating to a structure of that neural network, and the approximation evaluator information 26 that shows parameters, used by the neural network, as internal parameters. Also, the approximation evaluator 27 may be a polynomial expression, made up of a combination of information relating to a structure of the polynomial expression (form expression) and the approximation evaluator information 26 that shows coefficients of the polynomial expression as internal parameters.

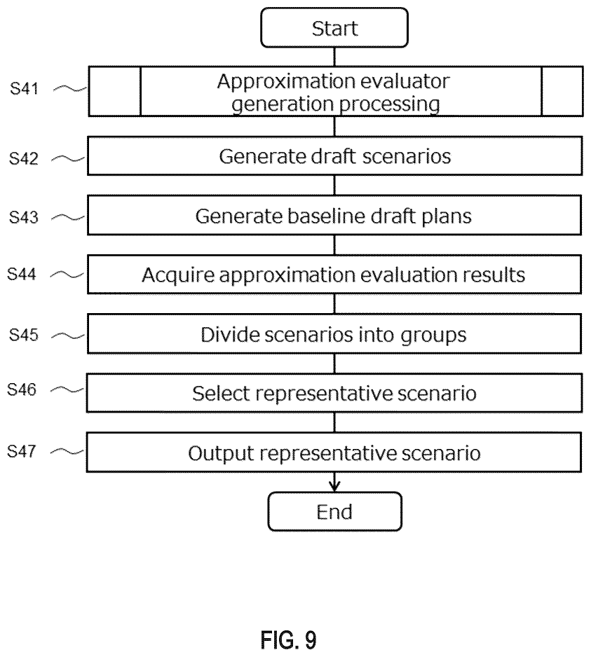

FIG. 9 is a flowchart for describing overall processing performed by the computation device 1.

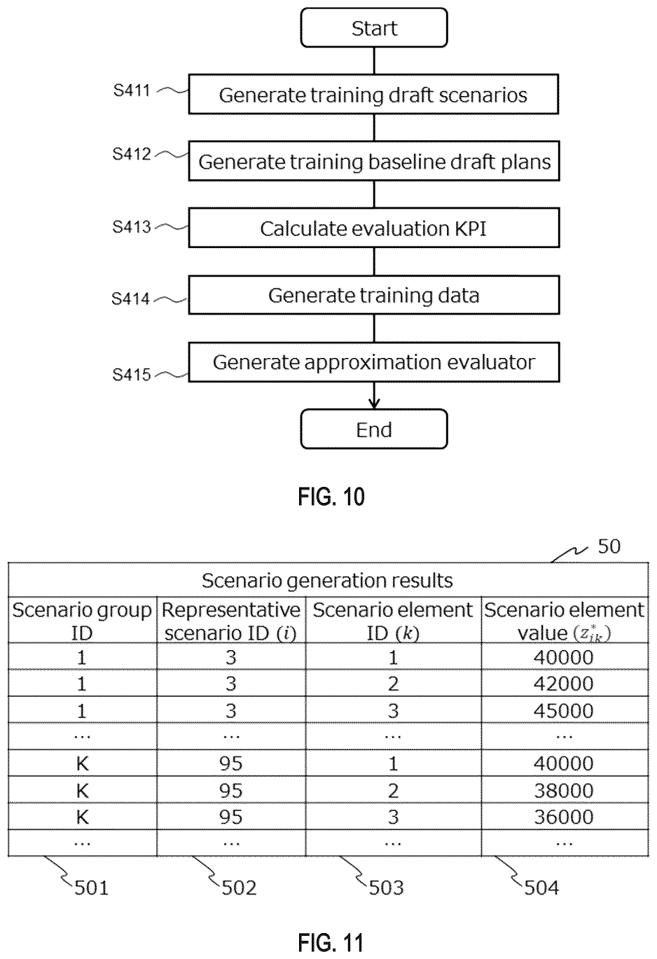

In step S41 in the overall processing, the approximation evaluator generation unit 32 generates the training data 25 using the strict evaluation unit 31, and executes approximation evaluator generation processing (see FIG. 10) for generating the approximation evaluator 27 using this training data. This approximation evaluator generation processing may be executed in advance, prior to the computation device 1 acquiring the risk distribution 21, for example.

Note that the strict evaluation unit 31 subjects the operational draft plans to high-precision evaluation, of which computation cost is high, using a strict evaluation model. The strict evaluation unit 31 is, for example, a simulator. Conversely, the approximation evaluator 27 subjects the operational draft plans to simple evaluation of which the computation cost is lower as compared to the strict evaluation unit 31. Computation costs are at least one of calculation amount, calculation time, computation resource amount needed for calculation, and so forth, for example. The approximation evaluator 27 may be realized as a machine learning model such as a neural network that approximatively performs evaluation by a simulator, may be a simulation model that is more abstract than the strict evaluation unit 31, may be a simple mathematical expression, or the like.

In step S42, the draft scenario generation unit 33 generates a plurality (an N count here) of draft scenarios based on the risk distribution 21 and the scenario generation conditions 23 (step S42). For example, the draft scenario generation unit 33 generates N draft scenarios by randomly sampling the values of the risk elements in the risk distribution 21, as scenario element values that are values of the draft scenarios, as many times as the draft scenario count (N times) indicated by the scenario generation conditions 23. Note that the draft scenarios are, for example, demand scenarios in SCM, and the scenario element values are a demand count of a certain product during a certain period. Note that a relatively great amount of draft scenarios are preferably generated to accurately evaluate uncertainty.

In step S43, the baseline draft plan generation unit 34 generates a plurality of (an M count here) of baseline draft plans based on the draft plan definition region 22 and the scenario generation conditions 23. For example, the baseline draft plan generation unit 34 generates M baseline draft plans by randomly sampling the values of the plan elements in the draft plan definition region 22, as baseline plan elements that are values of the baseline draft plans, as many times as the baseline plan count (M times) indicated by the scenario generation conditions 23. The baseline draft plan is, for example, an inventory placement plan, and a baseline plan element value is an inventory count of products in a certain warehouse during a certain period. Note that a relatively great amount of baseline draft plans are preferably generated to accurately select high-risk scenarios.

In step S44, the approximation evaluation unit 35 generates a plurality of operational draft plans, obtained by combining the N draft scenarios generated in step S42 and the M baseline draft plans generated in step S43, as input data, inputs the input data into the approximation evaluator 27, and acquires approximation evaluation results in which evaluation KPIs of the operational draft plan are approximatively calculated (step S44). The method of creating the input data may be, for example, a method of combining all draft scenarios and all baseline draft plans to create an M×N count of input data, a method of combining a count of draft scenarios and baseline draft plans selected by the user to create input data, or the like.

Note that the input data is generated by combining a relatively large amount of draft scenarios and baseline draft plans, as described above, and accordingly, the count of input data is extremely great. For example, in a case in which there are three types of evaluation KPIs, 10, 000 baseline draft plans, and 10,000 draft scenarios, the approximation evaluation unit 35 will have to perform the computation for calculating the evaluation KPIs 300,000,000 times. In this case, evaluating all input data using the strict evaluation unit 31 requires a tremendous amount of the computation costs. If there is no restriction on the computation costs, the strict evaluation unit 31 may be used, but in reality, there is restriction on the computation costs, and accordingly using the approximation evaluator 27 that is capable of evaluation with computation costs that are extremely small enables a great amount of operational draft plans to be evaluated within realistic computation costs.

In step S45, the draft scenario aggregation unit 36 aggregates the N draft scenarios into a plurality (a K count here) of scenario groups, based on the approximation evaluation results from the approximation evaluation unit 35 and the scenario generation conditions 23. The scenario aggregation count K that is the count of the scenario groups is sufficiently smaller than the draft scenario count N.

For example, an approximation evaluation result regarding an h'th evaluation KPI obtained by entering input data in which draft scenario i and baseline draft plan j are combined to the approximation evaluator 27 is defined as y_hij. Also, the evaluation weight of the h'th evaluation KPI is defined as w_h, with H types of the evaluation KPIs being defined. At this time, when defining a risk feature V_i indicating the degree of influence on the evaluation KPI of the draft scenario i as V_i={w_h×y_hij}={w_1×y_1i1, w_1×y_1i2, . . . , w_1×y_1iM, w_2×y_2i1, w_2×y_2i2, . . . , w_H×y_HiM}, the draft scenario aggregation unit 36 can acquire the risk features V_1 through V_N of the draft scenarios 1 through N. The risk features represent the characteristics of uncertainty (risk) and indicate that draft scenarios that have similar risk features as each other “have similar tendencies of risks regarding the baseline draft plan”. The draft scenario aggregation unit 36 executes aggregation processing of aggregating the N draft scenarios into K scenario groups, based on the risk features V_1 through V_N of the draft scenarios 1 through N, and the scenario generation conditions 23. The aggregation processing can be realized using a clustering technique such as, for example, K-Means, principal component analysis, t-SNE, or the like.

Also, the draft scenarios may be aggregated by the following method. That is to say, the draft scenario aggregation unit 36 divides the risk features by type of evaluation KPI, and defines the risk feature of the draft scenario concerning the h'th evaluation KPI as V_hi={y_hi1, y_hi2, . . . , y_hiM}. The draft scenario aggregation unit 36 then aggregates the N draft scenarios into K scenario groups for each evaluation KPI, based on these risk features V_h1 through V_hN and the scenario generation conditions 23. At this time, the scenario group to which the draft scenario i in the h'th evaluation KPI belongs is expressed by base-2 expression G_hi. In a case in which the scenario group to which the draft scenario i in the h'th evaluation KPI belongs is the Z'th, the Z'th value in the base-2 expression G_hi is 1 and the other values therein are 0. For example, in a case in which the count of scenario groups is four and Z is 2, the base-2 expression G_hi is {0, 1, 0, 0}. The draft scenario aggregation unit 36 calculates the risk features of the scenario i regarding all evaluation KPIs as a quantity G_i={w1×G_1i, w 2×G2_i, . . . , w_H×G_Hi}, and aggregates the N draft scenarios into K scenario groups based on this risk feature.

In step S46, the representative scenario selection unit 37 selects, for each scenario group, one of the draft scenarios belonging to that scenario group, as a representative scenario, based on the approximation evaluation results from the approximation evaluation unit 35. Here, the representative scenario selection unit 37 selects K representative scenarios by selecting one representative scenario from each of the K scenario groups.

For example, for each scenario group, the representative scenario selection unit 37 selects a representative scenario based on the risk feature of each draft scenario belonging to that scenario group. Specifically, the representative scenario selection unit 37 selects, for each scenario group, a draft scenario with the greatest scenario feature from among the draft scenarios belonging to that scenario group to be the representative scenario, as the highest-risk draft scenario out of that scenario group. The highest-risk draft scenario is the draft scenario with the highest degree of influence on the operational draft plan or the baseline draft plan. Also, the representative scenario selection unit 37 may calculate, for each scenario group, distances among draft scenarios belonging to that scenario group, and select the draft scenario that is closest to a center point at an equal distance from all draft scenarios as the representative scenario. Distances of the draft scenario are, for example, cosine similarity, Euclidean distance, or the like.

In step S47, the representative scenario selection unit 37 outputs output information including the K representative scenarios that are selected, and ends the processing.

Note that the overall processing described above is only an example, and this example is not limiting. For example, in step S43, the draft scenario generation unit 33 may search, regarding each draft scenario generated in step S42, a value of a plan element by which the approximation evaluation results become the best (i.e., the highest), using an optional search algorithm, and generate search results thereof as the baseline draft plan. The baseline draft plan generated by this method is a baseline draft plan with the lowest degree of influence on each draft scenario, and accordingly is close to a final operation plan, whereby precision of risk evaluation can be improved.

Also, the order in which the processing of step S42 and the processing of step S43 are carried out may be reversed, for example. In this case, in step S42, the draft scenario generation unit 33 may search, regarding each baseline draft plan generated in step S43, a value of a risk element by which the approximation evaluation results become the worst (i.e., become lowest) using an optional search algorithm, and generate the search result as the draft scenario. The draft scenario generated by this method is a draft scenario of which the degree of influence on each baseline draft plan is highest, and accordingly the precision of risk evaluation can be improved.

According to the above processing, a representative scenario that is characteristic can be selected from a greater number of scenarios, and accordingly planning of an operation plan, in which varied and high-risk uncertainties are evaluated, is enabled by evaluating a representative scenario group, even without evaluating an extremely great amount of draft scenarios as has been conventionally done. Accordingly, the time for creating an operation plan with uncertainties taken into account can be shortened. In particular, the K representative scenarios selected in the present embodiment are a stringent selection of draft scenarios that are most characteristic and different from each other, from among the M draft scenarios, with draft scenarios having similar tendencies excluded therefrom, from a perspective of the degree of influence on the evaluation KPIs. Accordingly, the time for creating an operation plan with uncertainties taken into account is shortened, and further sturdiness (robustness) of operation plans that are generated regarding uncertainties can also be improved.

FIG. 10 is a flowchart for describing an example of the approximation evaluator generating processing of step S41 in FIG. 9.

In step S411, the approximation evaluator generation unit 32 generates training draft scenarios that are a plurality of draft scenarios for training, to generate training data. For example, the approximation evaluator generation unit 32 may generate training draft scenarios by randomly sampling from the risk distribution 21, may generate the training draft scenarios by randomly sampling from past risk distributions, or may generate the training draft scenarios from past risk occurrence history.

In step S412, the approximation evaluator generation unit 32 generates training baseline draft plans that are a plurality of baseline draft plans for training, to generate training data. For example, the approximation evaluator generation unit 32 may generate the training baseline draft plans by randomly sampling from the draft plan definition region 22, or may generate the training baseline draft plans from past operational draft plans.

In step S413, for each operational draft plan for training in which training draft scenarios and training baseline draft plans are combined, the approximation evaluator generation unit 32 inputs the operational draft plan for training into the strict evaluation unit 31, and acquires output from the strict evaluation unit 31 as an evaluation KPI regarding the operational draft plan for training. At this time, the strict evaluation unit 31 is used, and accordingly the training draft scenarios and operational draft plans for training are preferably fewer than the draft scenarios and baseline draft plans for evaluation that are evaluated by the approximation evaluator 27. For example, in a case in which three types of evaluation KPIs are defined, and there are 1,000 training draft scenarios and 1,000 training baseline draft plans, the strict evaluation unit 31 will perform computation for calculating the evaluation KPIs 3,000,000 times.

In step S414, for each operational draft plan for training, the approximation evaluator generation unit 32 generates the operational draft plan for training and the evaluation KPI regarding the operational draft plan for training as one set of sample data, which is then added to the training data 25. In this case, the count of training data is 1,000,000 in the above-described example.

In step S415, the approximation evaluator generation unit 32 generates the approximation evaluator 27 based on the training data 25 generated in step S414. Due to the approximation evaluator 27 being generated in this way, the approximation evaluator 27 does not have to be prepared in advance. Also, with the baseline draft plan as x, the draft scenario as s, and the evaluation KPI as y, the approximation evaluator 27 is equivalent to function f in the following Expression 1.

y≈f(x,s) (Expression 1)

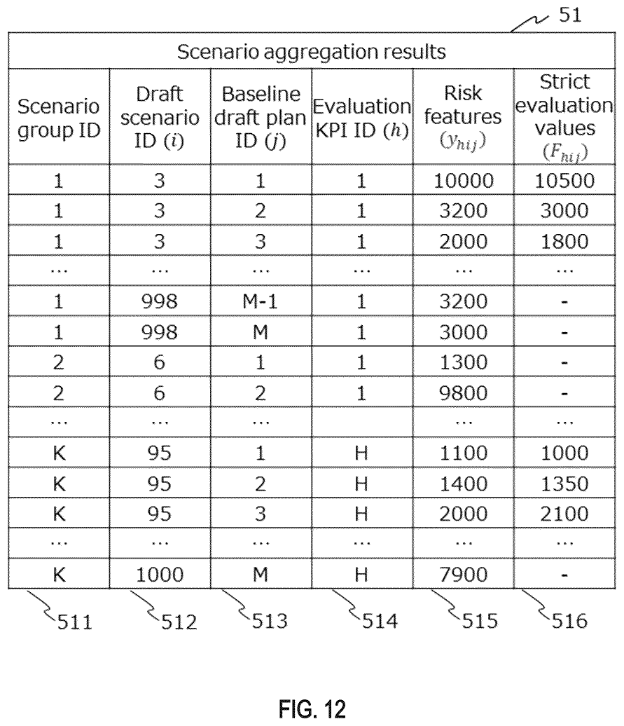

FIG. 11 and FIG. 12 are diagrams showing examples of output information of the computation device 1.

FIG. 11 is a diagram showing an example of scenario generation results, which is output information. The scenario generation results 50 shown in FIG. 11 include fields 501 through 504. The field 501 stores scenario group IDs for identifying scenario groups (scenario Gr.). The field 502 stores representative scenario IDs that are scenario IDS for identifying representative scenarios of the scenario groups. The field 503 stores scenario element IDs for identifying scenario elements included in the representative scenarios. The field 504 stores scenario element values that are scenario element values.

FIG. 12 is a diagram showing an example of scenario aggregation results, which are output information. The scenario aggregation results 51 shown in FIG. 12 include fields 511 through 516. The field 511 stores scenario group IDs for identifying the scenario groups. The field 512 stores scenario IDs for identifying draft scenarios included in the scenario groups. The field 513 stores baseline draft plan IDs for identifying the baseline draft plans. The field 514 stores evaluation KPI IDs for identifying the evaluation KPIs. The field 515 stores risk features regarding operational draft plans that are a combination of the draft scenarios of the scenario IDs stored in the field 512 and the baseline draft plans of the baseline draft plan IDs stored in the field 513. In a case in which strict evaluation results (strict evaluation values) regarding the operational draft plans are present, the field 516 stores these strict evaluation results. The strict evaluation results are the evaluation KPIs calculated by the strict evaluation unit 31.

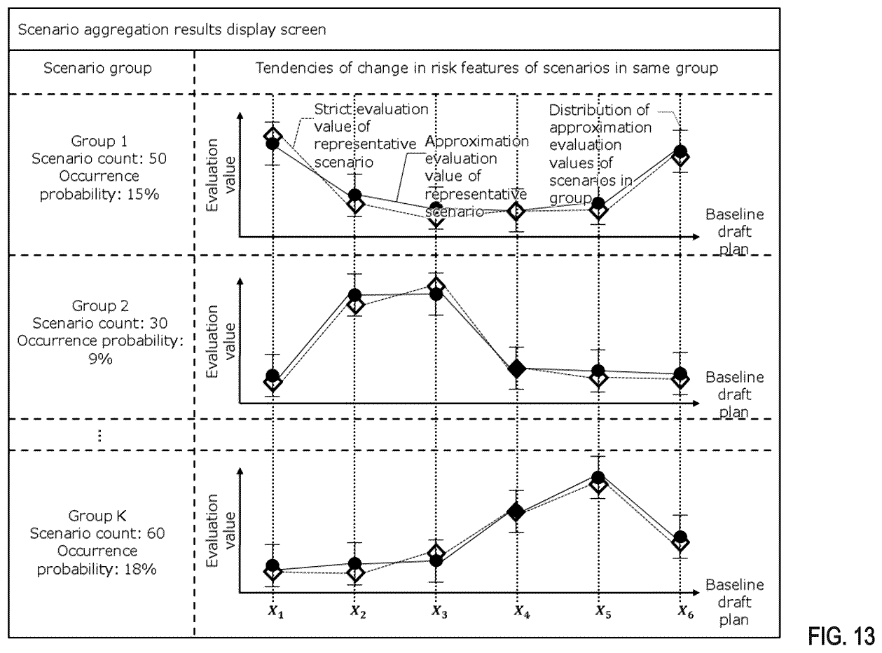

FIG. 13 to FIG. 15 are diagrams showing examples of display screens based on the output information.

FIG. 13 is a diagram showing an example of a scenario aggregation results display screen for displaying the processing results from the draft scenario aggregation unit 36 and the representative scenario selection unit 37. The scenario aggregation results display screen 60 shown in FIG. 13 shows, for each scenario group, the approximation evaluation results of the representative scenario thereof, the distribution of approximation evaluation results for the scenarios belonging to the scenario group, the strict evaluation results for the representative scenario, and so forth.

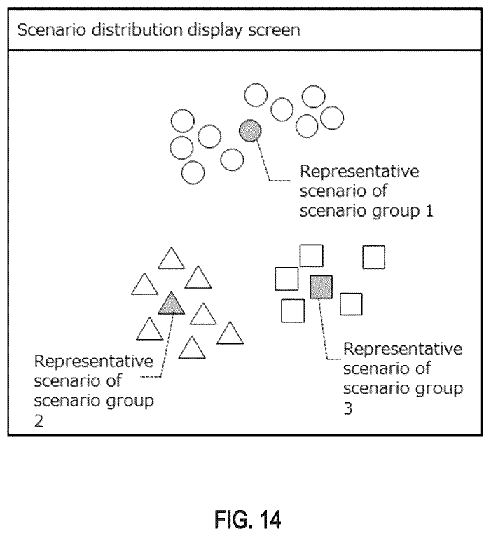

FIG. 14 is a diagram showing an example of a scenario distribution display screen for intuitive comprehension of relations among draft scenarios. The scenario distribution display screen 61 shown in FIG. 14 is an expression in which the draft scenarios are drawn on a plane while maintaining distance relations among the draft scenarios. In the scenario distribution display screen 61, draft scenarios included in the same scenario group are indicated by the same symbol (e.g., circles, squares, triangles, or the like), and further the representative scenario of each scenario group is indicated. Note that a dimension reduction technique such as, for example, principal component analysis, t-SNE, or the like, is used as a method for drawing on a plane in this way.

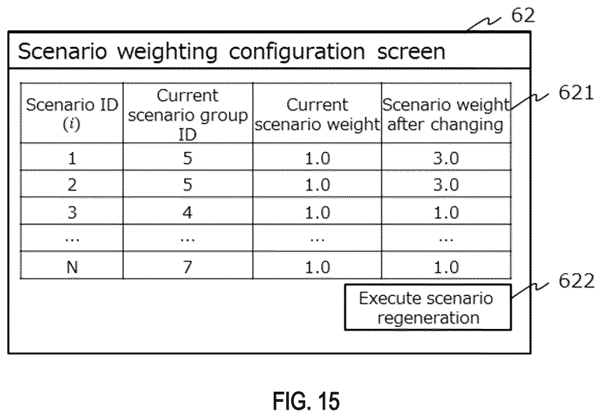

FIG. 15 is a diagram showing an example of a scenario weighting configuration screen for configuring weights for draft scenarios. The scenario weighting configuration screen 62 shown in FIG. 15 includes a configuration portion 621 for configuring scenario weights, and an execution button 622 for causing selection of representative scenarios to be executed with the scenario weights that are set. The configuration portion 621 shows, for each scenario ID of the draft scenarios, the scenario group ID of the scenario group to which the draft scenario belongs, the current scenario weight, and a scenario weight following changing.

The scenario weights are used for the representative scenario selection unit 37 to select a representative scenario, for example. At the time of selecting a representative scenario, the representative scenario selection unit 37 calculates distances based on the scenario weights (e. g., weighted Euclidian distances or the like) as distances among the scenarios, for example. In this case, draft scenarios with greater scenario weights are selected as representative scenarios more readily.

### Modification 1

In the first embodiment described above, the computation device 1 has been described as a single hardware device. However, the computation device 1 may be made up of a plurality of hardware devices, and each function may be realized by a different computer. In this case, the functions of the computation device 1 may be realized by a plurality of pieces of hardware that are connected to each other by a network and that are also located at physically remote locations.

### Second Embodiment

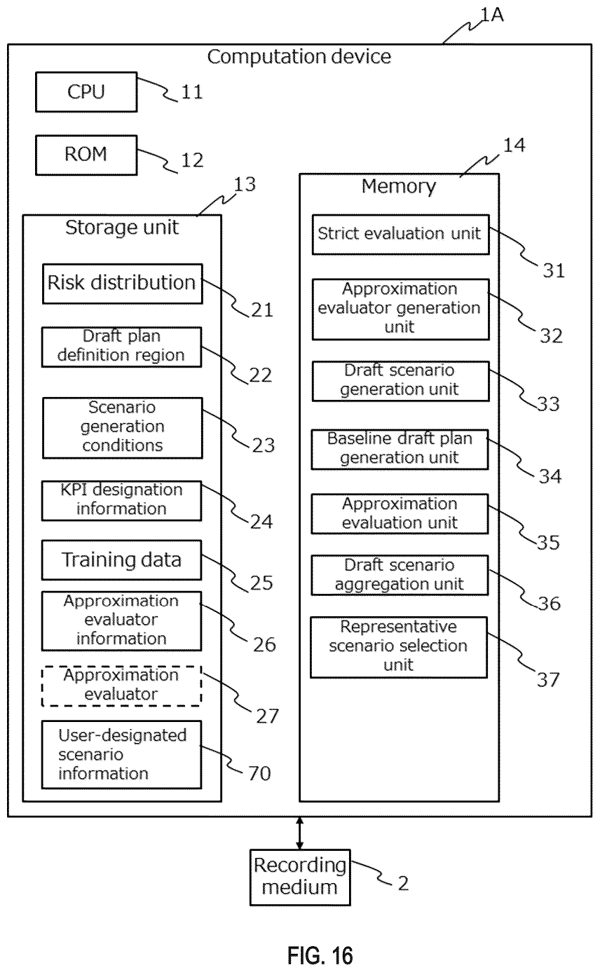

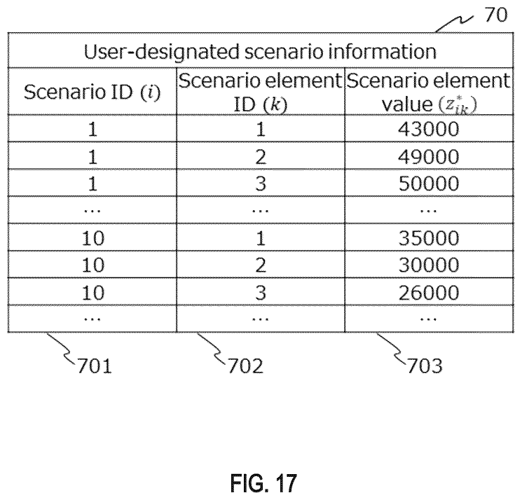

A second embodiment of the present disclosure will be described below concerning FIG. 16 and FIG. 17. Points of difference concerning the first embodiment will be primarily described below. The present embodiment differs from the first embodiment concerning the point that draft scenarios primarily instructed by a user can be input.

FIG. 16 is a configuration diagram illustrating a configuration of a computation device 1A according to the second embodiment. The computation device 1A illustrated in FIG. 16 differs concerning the point of the storage unit 13 further storing user-designated scenario information 70, in addition to the configuration of the computation device 1 according to the first embodiment illustrated in FIG. 2.

The user-designated scenario information 70 is designation information for designating at least part of the draft scenarios generated by the draft scenario generation unit 33. In a case in which the user designates N′ draft scenarios in the user-designated scenario information 70, the draft scenario generation unit 33 registers the N′ scenarios designated in the user-designated scenario information 70 as draft scenarios, and further generates the remaining N minus N′ draft scenarios based on the risk distribution 21.

FIG. 17 is a diagram showing an example of the user-designated scenario information 70. The user-designated scenario information 70 shown in FIG. 17 includes fields 701 through 703. The field 701 stores scenario IDs for identifying designated scenarios that are scenarios designated by the user. The field 702 stores scenario element IDs for identifying scenario elements included in the designated scenarios. The field 703 stores scenario element values that are scenario element values.

As described above, according to the present embodiment, the draft scenario generation unit 33 generates a predetermined count (an N count) of draft scenarios including draft scenarios designated by the user. Accordingly, important draft scenarios and so forth can be taken into account, and accordingly sturdiness concerning uncertainty can be further improved.

### Third Embodiment

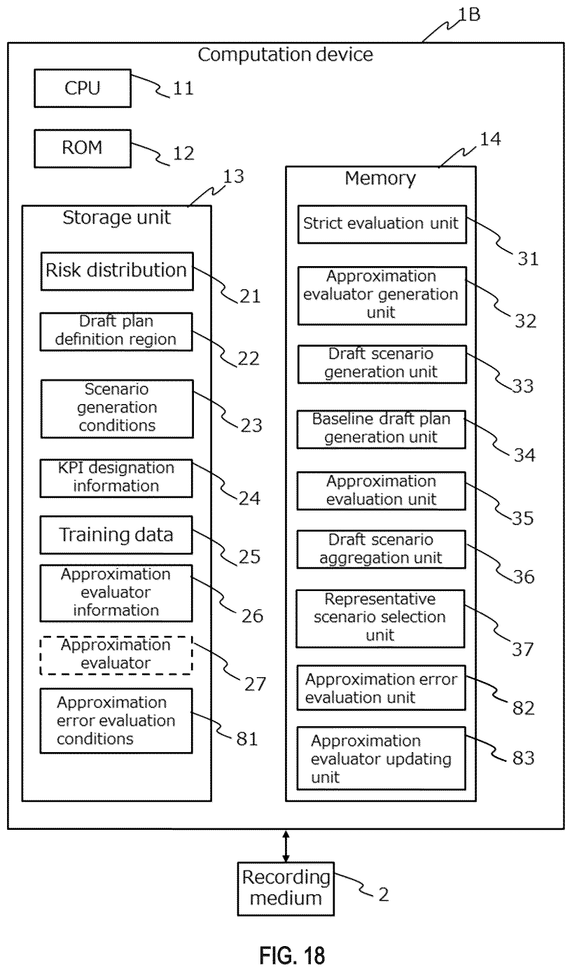

A third embodiment of the present disclosure will be described below concerning FIG. 18 to FIG. 20. Points of difference concerning the first embodiment will be primarily described below. The present embodiment primarily differs from the first embodiment concerning the point that during computation processing, evaluation results from the strict evaluation unit 31 are used to successively update the approximation evaluator 27 in the approximation evaluation unit 35, thereby improving the precision of the approximation evaluator 27.

FIG. 18 is a configuration diagram illustrating a configuration of a computation device 1B according to the third embodiment. The computation device 1B illustrated in FIG. 18 further stores approximation error evaluation conditions 81 in the storage unit 13, and also further includes an approximation error evaluation unit 82 and an approximation evaluator updating unit 83 as functional configurations, in addition to the configuration of the computation device 1 according to the first embodiment illustrated in FIG. 2.

The approximation error evaluation conditions 81 indicate evaluation conditions for the evaluation of approximation error, which is an error between strict evaluation results and approximation evaluation results.

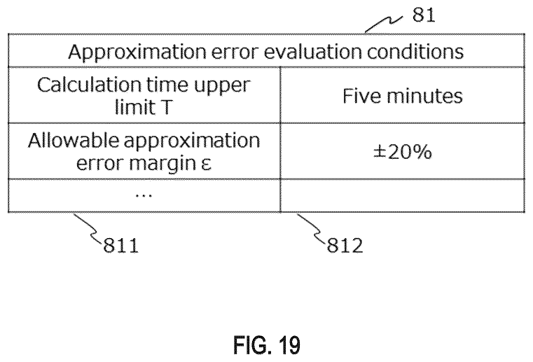

FIG. 19 is a diagram showing an example of the approximation error evaluation conditions 81. The approximation error evaluation conditions 81 shown in FIG. 19 include a calculation time upper limit T and an allowable approximation error margin ε as evaluation conditions. The calculation time upper limit T is an allowable upper limit value for processing time relating to the selection of representative scenarios. The allowable approximation error margin ε is an allowable value for approximation error.

The approximation error evaluation unit 82 is an error evaluation unit that evaluates approximation error that is error between strict evaluation results and approximation evaluation results of a confirmational operational draft plan, which is a combination of a representative scenario selected by the representative scenario selection unit 37 and one of baseline draft plans generated by the baseline draft plan generation unit 34. The approximation evaluator updating unit 83 is an updating unit that updates the approximation evaluator 27 based on the evaluation results from the approximation error evaluation unit 82.

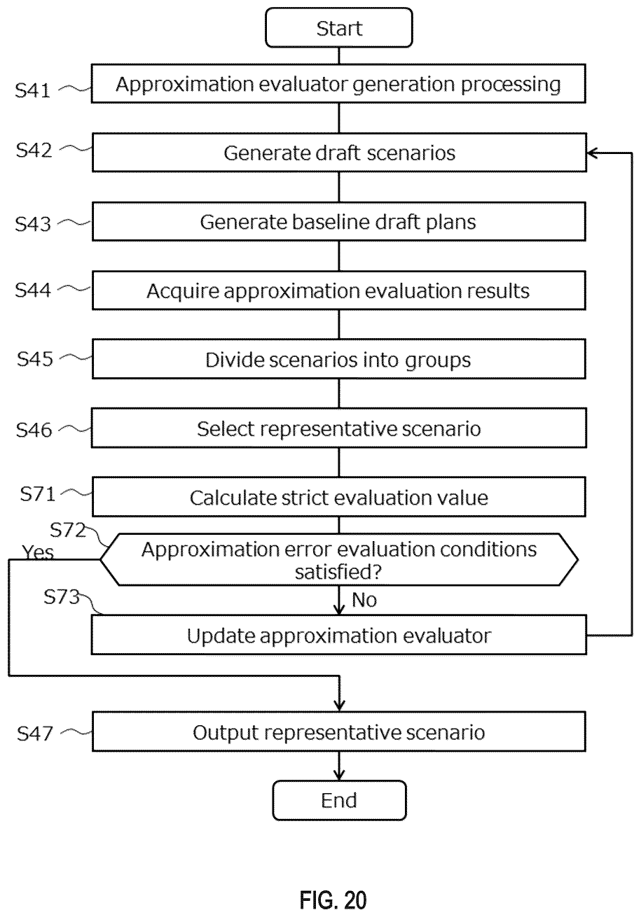

FIG. 20 is a flowchart for describing overall processing performed by the computation device 1B.

First, the processing of steps S41 through S46 (see FIG. 9) in the overall processing according to the first embodiment is executed, and thereafter, the processing of step S71 is executed.

In step S71, the strict evaluation unit 31 calculates evaluation KPIs obtained by evaluation of confirmational operational draft plans in which the representative scenario i generated in step S46 and an optional baseline draft plan j are combined, as strict evaluation results. Strict evaluation results regarding the h'th evaluation KPI are defined as Y_hij. At this time, it is sufficient for the computation by the strict evaluation unit 31 to be performed regarding a combination of the representative scenario i and one or more of the baseline draft plans. That is to say, the computation by the strict evaluation unit 31 may be performed regarding combinations of the representative scenario i and all baseline draft plans, or may be performed regarding a combination of the representative scenario i and part of the baseline draft plans.

In step S72, for each evaluation KPI, the approximation error evaluation unit 82 evaluates the approximation error between the strict evaluation results Y_hij calculated in step S71 and the approximation evaluation results y_hij calculated in step S44 and determines whether the approximation error satisfies the approximation error evaluation conditions 81.

The approximation error e is, for example, an average absolute error rate. In this case, the approximation error e is defined by the following Expression 2.

e=ΣE[|Y_hij−y_hij|] (Expression 2)

wherein |x| represents an absolute value of x, and E[x] represents an average value of x. In this case, the allowable approximation error margin s indicates an approximation error upper limit value that is the upper limit value of the approximation error e (average absolute error rate). Also, the approximation error evaluation unit 82 determines whether or not the approximation error e is smaller than the approximation error upper limit value, and whether or not the calculation time up to this time point (time from the processing of steps S41 or S42 being executed up to the current time point) is greater than the calculation time upper limit T.

In a case in which the total value of the approximation error e is smaller than the approximation error upper limit value, or in a case in which a calculation time t is greater than the calculation time upper limit T, the approximation error evaluation unit 82 determines that the approximation error evaluation conditions 81 are satisfied, and advances to the processing of step S47 described in FIG. 9. Also, in a case in which the total value of the approximation error e is equal to or greater than the approximation error upper limit value, and in a case in which the calculation time t is smaller than the calculation time upper limit T, the approximation error evaluation unit 82 advances to the processing of step S73.

In step S73, the approximation evaluator updating unit 83 adds the combination of the strict evaluation results Y_hij of the operational draft plan for evaluation that is calculated in step S71 and the operational draft plan for evaluation thereof to the training data 25 as a sample. The approximation evaluator updating unit 83 then updates the approximation evaluator 27 using this training data, and returns to the processing of step S42.

This updating processing may be realized by reexecuting processing the same as the approximation evaluator generation processing described in step S41, using the entire training data 25 including the sample added thereto, for example. Also, the updating processing may be performed using only the sample that is added and samples similar thereto, to raise the speed of processing. Also, the updating processing may be performed using the training data 25, with only a part of parameters of the approximation evaluator 27 being updatable.

As described above, according to the present embodiment, in a case in which the approximation error is great, the approximation evaluator 27 can be updated using strict evaluation results, and accordingly the approximation evaluator 27 can be updated such that the approximation error is smaller. Accordingly, the evaluation performance of the approximation evaluator 27 can be improved.

Note that in the embodiments and modifications described above, the configurations of functional blocks are only example. Several functional configurations that were illustrated as separate functional blocks may be integrally configured, and a configuration represented by a single functional block diagram may be divided into two or more functions. Also, a configuration may be made in which part of functions, which each functional block has, is included in other functional blocks.

Also, in the embodiments and modifications described above, the programs are described as being stored in the ROM 12, but the programs may be stored in the storage unit 13. Also, the computation device 1 may include an input/output interface that is omitted from the illustration, with programs being read in from other devices via the input/output interface and a medium that is usable by the computation device 1, whenever necessary. The medium as used here means, for example, a storage medium or communication medium that is detachably attachable to the input/output interface, i.e., a network that is wired, wireless, optical, or the like, or carrier waves or digital signals that are propagated over the network. Also, part or all of the functions realized by the programs may be realized by hardware circuits or FPGAS.

The above-described embodiments and modifications may each be combined. Although various embodiments and modifications have been described above, the present invention is not limited to the contents thereof. Other forms that are conceivable within the scope of the technical idea of the present invention are also encompassed within the scope of the present invention.

### REFERENCE SIGNS LIST

1, 1A, 1B Computation device
11 CPU
12 ROM
13 Storage unit
14 Memory
21 Risk distribution
22 Draft plan definition region
23 Scenario generation condition
24 KPI designation information
25 Training data
26 Approximation evaluator information
27 Approximation evaluator
31 Strict evaluation unit
32 Approximation evaluator generation unit
33 Draft scenario generation unit
34 Baseline draft plan generation unit
35 Approximation evaluation unit
36 Draft scenario aggregation unit
37 Representative scenario selection unit
50 Scenario generation result
51 Scenario aggregation result
60 Scenario aggregation results display screen
61 Scenario distribution display screen
62 Scenario weighting configuration screen
63 Approximation evaluator updating unit
70 User-designated scenario information
72 Approximation error evaluation unit
81 Approximation error evaluation condition
82 Approximation error evaluation unit
83 Approximation evaluator updating unit

1. A computation device for assisting in planning of an operation plan regarding a planning target, the computation device comprising:
a draft scenario generation unit configured to generate, based on uncertainty information which values of an uncertainty parameter relating to uncertainty concerning the planning target are expressed as a probability, a plurality of draft scenarios indicating values that the uncertainty parameter can take;
a baseline draft plan generation unit configured to generate, based on definition region information indicating a range of values of a determinate parameter relating to the planning target that is different from the uncertainty parameter, a plurality of baseline draft plans indicating values that the determinate parameter can take;
an approximation evaluation unit configured to acquire, by using an approximation evaluator that has learned strict evaluation results evaluated a plurality of an operational draft plans for training obtained by a strict evaluator that evaluates an operational draft plan, which is a combination of the draft scenarios and the baseline draft plans, approximation evaluation results in which a plurality of the operational draft plans for evaluation are evaluated;
an aggregation unit configured to aggregate the draft scenarios into a plurality of groups, based on the approximation evaluation results; and
a selection unit configured to select, for each of the groups, one of the draft scenarios belonging to that group as a representative scenario, based on the approximation evaluation results.

2. The computation device according to claim 1, further comprising:
an approximation evaluator generation unit configured to generate the approximation evaluator by causing the strict evaluator to evaluate a combination of the draft scenarios for training and the baseline draft plans for training as the operational draft plans for training.

3. The computation device according to claim 1, wherein the aggregation unit is configured to calculate, based on the approximation evaluation results, for each draft scenario, a degree of influence of that draft scenario on the approximation evaluation results, and aggregate the draft scenarios into a plurality of groups based on the degree of influence.

4. The computation device according to claim 3, wherein the selection unit is configured to select, for each group, the representative scenario based on the degree of influence of the draft scenarios belonging to that group.

5. The computation device according to claim 1, wherein the draft scenario generation unit is configured to search, for each of the plurality of baseline draft plans, a value of the uncertainty parameter by which the approximation evaluation results become the lowest, and generate that search result as the draft scenario.

6. The computation device according to claim 1, wherein the baseline draft plan generation unit is configured to search, for each of the plurality of draft scenarios, a value of the determinate parameter by which the approximation evaluation results become the highest, and generate that search result as the baseline draft plan.

7. The computation device according to claim 1, wherein the draft scenario generation unit is configured to generate a predetermined count of draft scenarios including a draft scenario designated by a user.

8. The computation device according to claim 1, further comprising:
an error evaluation unit configured to evaluate error between the strict evaluation results and the approximation evaluation results, regarding a confirmational operational draft plan in which the representative scenario and one of the baseline draft plans are combined; and
an updating unit configured to update the approximation evaluator based on the evaluation results from the error evaluation unit.

9. A planning assistance method performed by a computation device for assisting in planning of an operation plan regarding a planning target, the planning assistance method comprising:
generating, based on uncertainty information in which values of an uncertainty parameter relating to uncertainty concerning the planning target are expressed as a probability, a plurality of draft scenarios indicating values that the uncertainty parameter can take;
baseline draft plan generating for generating, based on definition region information indicating a range of values of a determinate parameter relating to the planning target that is different from the uncertainty parameter, a plurality of baseline draft plans indicating values that the determinate parameter can take;
acquiring, by using an approximation evaluator that has learned strict evaluation results evaluated a plurality of an operational draft plans for training obtained by a strict evaluator that evaluates an operational draft plan, which is a combination of the draft scenarios and the baseline draft plans, approximation evaluation results in which a plurality of the operational draft plans for evaluation are evaluated;
aggregating the draft scenarios into a plurality of groups, based on the approximation evaluation results; and
selecting, for each of the groups, one of the draft scenarios belonging to that group as a representative scenario, based on the approximation evaluation results.

10. A program for causing a computer for assisting in planning of an operation plan regarding a planning target to realize:
a draft scenario generation unit configured to generate, based on uncertainty information in which values of an uncertainty parameter relating to uncertainty concerning the planning target are expressed as a probability, a plurality of draft scenarios indicating values that the uncertainty parameter can take;
a baseline draft plan generation unit that generates, based on definition region information indicating a range of values of a determinate parameter relating to the planning target that is different from the uncertainty parameter, a plurality of baseline draft plans indicating values that the determinate parameter can take;
an approximation evaluation unit configured to acquire, by using an approximation evaluator that has learned strict evaluation results evaluated a plurality of an operational draft plans for training obtained by a strict evaluator that evaluates an operational draft plan, which is a combination of the draft scenarios and the baseline draft plans, approximation evaluation results in which a plurality of the operational draft plans for evaluation are evaluated;
an aggregation unit configured to aggregate the draft scenarios into a plurality of groups, based on the approximation evaluation results; and
a selection unit configured to select, for each of the groups, one of the draft scenarios belonging to that group as a representative scenario, based on the approximation evaluation results.
